(19) United States
(12) Patent Application Publication
(10) Pub. No.: US 2009/0032394 A1
(43) Pub. Date: Feb. 5, 2009

(54) IONIC POLYMER DEVICES AND METHODS OF FABRICATING THE SAME

(75) Inventors: Yongxian Wu, Irvine, CA (US); Yangyang Li, Irvine, CA (US)

Correspondence Address: KNOBBE MARTENS OLSON & BEAR LLP, 2040 MAIN STREET, FOURTEENTH FLOOR, IRVINE, CA, 92614, US

(73) Assignees: HITACHI CHEMICAL CO., LTD., TOKYO (JP); HITACHI CHEMICAL RESEARCH CENTER, INC., IRVINE, CA (US)

(21) Appl. No.: 12/161,941

(22) PCT Filed: Jan. 23, 2007
(86) PCT No.: PCT/US2007/001853

§ 371 Date: Jul. 23, 2008

Related U.S. Application Data
(60) Provisional application No. 60/761,175, filed on Jan. 23, 2006.

(51) Int. Cl. G01N 27/30; B05D 5/12; G01N 27/28

(52) U.S. Cl. 204/400; 427/77; 204/242

(57) ABSTRACT

An embodiment provides an ionic polymer device comprising two extended electrode layers comprising a plurality of conductive particles, wherein the plurality of conductive particles form a concentration gradient in each of the two extended electrode layers, an ionic polymer dielectric layer between two extended electrode layers, and at least one conductive layer on outer surfaces of two extended electrode layers. Another embodiment provides an ionic polymer device comprising a polymer composite with a plurality of surface features on two opposite surfaces, and at least one conductive layer on each of said two opposite surfaces. One embodiment provides a method of making an ionic polymer device, comprising forming a partially cured polymer-metallic salt layer, reducing the metallic salt to form a plurality of metal particles, thereby forming a first extended electrode layer and a second extended electrode layer at and near opposite surfaces of the ionic polymer device.

### CROSS REFERENCE TO RELATED APPLICATIONS

This application claims priority to U.S. Provisional Application No. 60/761175, filed Jan. 23, 2006, which is incorporated by reference, in its entirety.

### BACKGROUND OF THE INVENTION

1. Field of the Invention

The present invention relates to novel ionic polymer device structures and novel methods of fabricating ionic polymer devices that can be configured as actuators, sensors, and transducers.

2. Description of the Related Art

Ionic polymer or ionomer composite material is one of the emerging classes of electroactive polymers and functional smart materials that can be made into soft bending actuators and sensors. The material was originally manufactured for fuel cell applications and its unique biomimetic sensing-actuating properties were not found until 1992. A typical ionomeric actuator/sensor element comprises a thin polyelectrolyte ionomer membrane of about 200 μm thick in the middle and plated metal layers on two opposite surfaces with the thickness of each metal layer ranged from 5 to 20 μm. The ionomer membrane is usually made of perfluoro-sulfonic polymer (Nafion®) or perfluoro-carboxylic polymer (Flemion®). These ionomer membranes have a hydrophobic fluorocarbon backbone with hydrophilic side chains that form interconnected clusters in the presence of a solvent such as water, organic solvent or ionic liquid. The hydrophilic side chains may include but not limited to fixed anions such as —SO₃⁻ and —COO⁻. The ionic polymer may be neutralized with a certain cation or a combination of various cations. Suitable cations include alkali metals such as Li⁺, Na⁺, K⁺, Rb⁺ and Cs⁺ and organic cations such as alkyl ammonium.

When a potential is applied to the ionic polymer actuator, the unbound cations can move in and out of the clusters through the solvent and redistribute within the ionic polymer itself to form anode and cathode boundary layers. The change in electrostatic force and osmotic pressure, balanced by the elastic resistance, drives solvent into or out of the boundary layer clusters, and causes change in the volumes of interconnected clusters at this boundary-layer. This change in volume leads to the deformation or bending of the actuator. The charge distribution and the change in water uptake may be calculated by a coupled chemo-electro-mechanical formulation.

Ionic polymer materials offer significant advantages over conventional electromechanical materials and systems due to their compact sizes, light weight and the ability to be cut into any shape from the fabricated material. The fabricated device requires only modest operating voltage. The ionic polymer actuator can respond to small electric stimulus by generating large bending deformation, while the ionic polymer sensor responds to mechanical deformation (or vibration) by generating electrical signals. The sudden bent of the ionic polymer produces a small voltage (in the range of mV). In addition, the actuating/sensing function can be tailored by changing the micro-structure, the electrical input, the cation composition, and the solvent type and amount. The material is biocompatible and can be operated in various kinds of solvents. It may be developed to provide new, self-integrated material systems for biomedical and robotic applications.

One of many factors that can affect the coupled chemo-electro-mechanical responses of an ionic polymer based sensor/actuator is the electrode morphology and effective electrical capacitance. Traditional fabrication method for forming electrodes on an ionic polymer device involves first roughening and cleaning the surface of an already cured polymer membrane, allowing a substance capable of undergoing chemical reduction to be absorbed from the polymer surfaces, and reducing the absorbed substance to form electrodes. It normally requires repeated absorbing and reduction steps to allow more substance to diffuse into the ionic polymer membrane, and therefore a lengthy and expensive process. However, the diffusion of substance into a polymer membrane is still limited to less than about 20 microns from the membrane surface. Not only is the fabrication process expensive, the performance of the ionic polymer actuator/sensor is also affected by the diffusion limitation of the conductive material.

### SUMMARY OF THE INVENTION

The object of this invention is to provide novel ionic polymer device or ionic polymer actuator/sensor and the fabrication techniques that allow for simpler, cheaper and faster manufacturing processes. The fabrication methods increase electrical capacitance of the ionic polymer device by creating a large interfacial area between the polymer phase and the electrically conductive phase or electrodes, thereby improving its actuation performance and sensitivity.

The methods and devices of the invention each have several aspects, and no single one of which is solely responsible for its desirable attributes. Without limiting the scope of this invention, its more prominent features will be discussed briefly.

An embodiment provides an ionic polymer device comprising two extended electrode layers comprising a plurality of conductive particles, wherein the plurality of conductive particles form a concentration gradient in each of the two extended electrode layers; an ionic polymer dielectric layer between two extended electrode layers; and at least one conductive layer on outer surfaces of two extended electrode layers.

Another embodiment provides an ionic polymer device comprising a polymer composite with a plurality of surface features on two opposite surfaces; and at least one conductive layer on each of said two opposite surfaces.

One embodiment provides a method of making an ionic polymer device, comprising providing a mixture comprising at least one metallic salt in an ionic polymer solution; curing the mixture to form at least one partially cured polymer layer having a first surface and a second surface, wherein the at least one partially cured polymer layer comprises the at least one metallic salt; and reducing said at least one metallic salt to form a plurality of metal particles, thereby forming a first extended electrode layer at and near the first surface. Another embodiment further comprises reducing said at least one metallic salt to form a plurality of metal particles, thereby forming a second extended electrode layer at and near the second surface.

Another embodiment provides a method of making an ionic polymer device, comprising providing a mixture comprising at least one metallic salt in an ionic polymer solution; curing the mixture to form at least one partially cured polymer layer having a first surface and a second surface, wherein the at least one partially cured polymer layer comprises the at least one metallic salt; reducing said at least one metallic salt to form a plurality of metal particles, thereby forming a first extended electrode layer at and near the first surface. Another embodiment further comprises forming two cured polymer layers by allowing the at least one partially cured polymer layer to cure; providing an ionic polymer dielectric layer; and combining two cured polymer layers and the dielectric layer to form a polymer composite.

Another embodiment provides a method of making an ionic polymer device, comprising providing at least one mixture comprising a plurality of conductive particles in an ionic polymer solution; forming at least one extended electrode layer comprising a plurality of conductive particles by curing the at least one mixture; providing an ionic polymer dielectric layer on one of the at least one extended electrode layer; and depositing at least one conductive layer on the outer surface of the at least one extended electrode layer.

Yet another embodiment provides a method of making an ionic polymer device, comprising providing at least one imprinting plate; providing an ionic polymer solution; and applying the ionic polymer solution on the at least one imprinting plate, thereby forming at least one imprinted polymer layer with surface features.

### BRIEF DESCRIPTION OF THE DRAWINGS

These and other aspects of the invention will be readily apparent from the following description and from the appended drawings (not to scale), which are meant to illustrate and not to limit the invention, and wherein:

FIG. 1 illustrates one embodiment of an actuator/sensor device according to the present invention.

FIG. 2 illustrates another embodiment of an actuator/sensor device according to the present invention.

FIGS. 3A to 3C show different cross-sectional particle concentration profiles along the polymer composite thickness of three embodiment of the device in FIG. 1.

FIG. 4 shows a flow chart illustrating a process for forming the polymer composite of an ionic polymer device of FIG. 1.

FIG. 5 shows a cross-section of one embodiment of a polymer composite of an ionic polymer device of FIG. 1.

FIG. 6A shows a cross-sectional view of two polymer-particle layers to be bonded to form one embodiment of a polymer composite.

FIG. 6B shows a cross-sectional view of two polymer-particle layers and one ionic polymer dielectric layer to be bonded to form another embodiment of a polymer composite.

FIG. 7 shows a flow chart illustrating another process for forming the polymer composite of an ionic polymer device of FIG. 1.

FIG. 8 shows a cross-section of one embodiment of the composite layer formed in a container.

FIG. 9A shows a cross-sectional view of two polymer-particle layers and one ionic polymer dielectric layer to be bonded to form one embodiment of a polymer composite.

FIG. 9B shows a cross-sectional view of four polymer-particle layers and one ionic polymer dielectric layer to be bonded to form another embodiment of a polymer composite.

FIG. 9C shows a cross-sectional view of another embodiment of two polymer-particle layers and one ionic polymer dielectric layer to be bonded to form a polymer composite.

FIG. 10 shows a flow chart illustrating a process for forming the polymer composite of an ionic polymer device of FIG. 2.

FIG. 11A shows a cross-section of one embodiment of a polymer composite with attached imprinting plates.

FIG. 11B shows a cross-section of one embodiment of a polymer composite after the imprinting plates have been removed.

FIG. 12 shows a cross-sectional view of two imprinted layers and a solid ionic polymer layer to be bonded to form one embodiment of the ionic polymer device.

FIG. 13 is a result of energy dispersive X-ray scanning (EDS) analysis of gold concentration along the thickness of one embodiment of an extended electrode layer.

### DETAILED DESCRIPTION OF THE PREFERRED EMBODIMENT

The following detailed description is directed to certain specific embodiments of the invention. However, the invention can be embodied in a multitude of different ways. In this description, reference is made to the drawing wherein like parts are designated with like numerals throughout.

Embodiments of this invention provide a novel method for fabricating ionic polymer devices. Some embodiments can also be configured as a sensor or an actuator. The quality of actuation and sensing responses, which result from the coupled chemo-electro-mechanical interactions at the nano-scale level, depends on the structure of the polymer composite, the morphology of the conductive phase, the nature of the cation, the solvent type, and the applied electrical signal.

Embodiments of methods of present invention are designed to increase the interfacial area between the polymeric phase and the conductive phase for optimizing the performance and sensitivity of various ionic polymer devices. The enhanced electrode morphology allows the ionic polymer devices made by this method to exhibit a large effective electrical capacitance, and therefore achieve an increased actuation and/or sensing capability. The methods of this invention also enable efficient fabrication of functional polymer composites. The process involves fewer steps and allows for a greater control over the structure of the ionic polymer composite. The process is simple, less expensive and more efficient Certain embodiments of the methods are suitable to be adopted for manufacturing ionic polymer devices in a variety of dimensions such as micro- to centimeter-scale thicknesses, and different configurations such as single devices, sensor/actuator arrays, systems or complex devices.

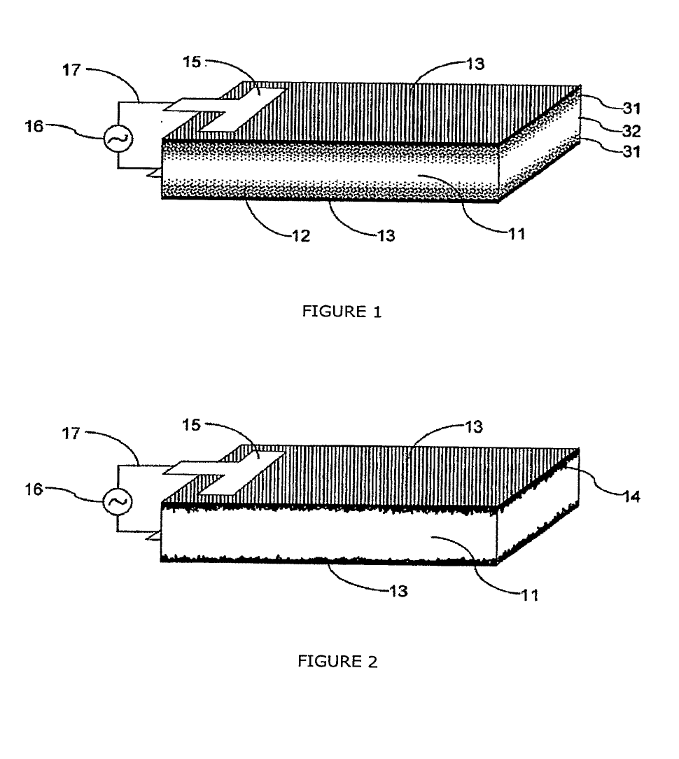

FIG. 1 depicts certain embodiments of the ionic polymer device a polymer composite 11 and at least one conductive layer 13 on two opposite surfaces of the polymer composite 11. The polymer composite is made of at least one ionic polymer. Ionic polymer, also known as ion-exchange polymer or ionomer, may be either cation exchange polymers with sulfonic acid or carboxylic acid groups or anion exchange polymers with trimethylammonium or amino groups. Examples of ionic polymer useful for various embodiments of this invention include, but are not limited to: perfluoro-sulfonic polymer, perfluoro-carboxylic polymer, polystyrene-sulfonic polymer and perfluoro-tertiary ammonium polymer. In some embodiments, the thickness of the polymer composite 11 may be a few microns to centimeters depending on the application. In preferred embodiments, the thickness of the entire polymer composite may be from about 1 μm to about 10 cm, preferably about 10 μm to about 1 cm, and more preferably about 100 μm to about 1 mm.

The polymer composite comprises two extended electrode layers 31 and an ionic polymer dielectric layer 32 sandwiched between two extended electrode layers 31. Each of the two extended electrode layers 31 comprises a plurality of conductive particles 12. In some embodiments, the plurality of conductive particles 12 forms a concentration gradient in each of the two extended electrode layers 31. In some embodiments, the plurality of conductive particles 12 is well-dispersed within the extended electrode layer 31. The plurality of conductive particles is considered well-dispersed when the particles are not aggregated, and in some embodiments, the particles may be close to mono-dispersed. Generally, the conductive particles 12 may be any nano- or micro-scale particles that are electrically conductive. Non-limiting examples of conductive particles 12 are metal particles such as Pt, Au, Ag, Ni, Cu, and Pd, and non-metal particles such as conducting polymers, carbon nanotubes, and graphite. The metal particles may be of any shape, and may be preformed, formed by metallic-salt reduction in the polymer or commercially available. The thickness of each extended electrode layer 31 may be about 1% to about 45%, preferably about 5% to about 25% and more preferably about 10% to about 20% of the entire polymer composite thickness.

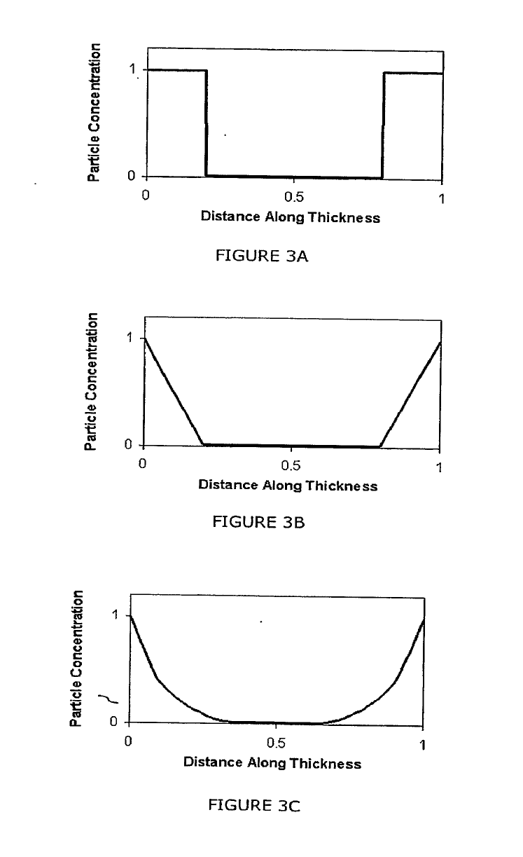

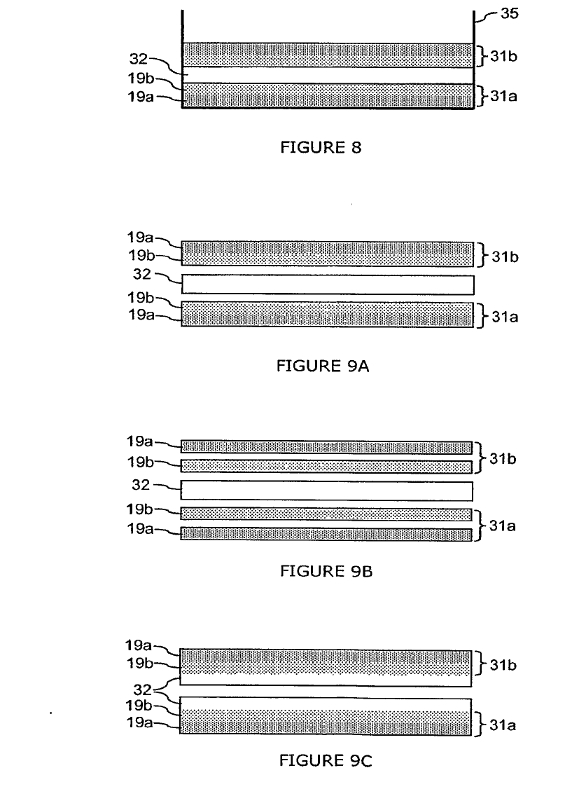

The conductive particles 12 may be well-dispersed within an extended electrode layer 31, or may form a concentration gradient due to gravitational force. The concentration profiles of conductive particles 12 in certain embodiments are displayed in FIGS. 3A-3C. In some embodiments, the extended electrode layer 31 may comprise at least one polymer-particle layer 19 or multiple polymer-particle layers (see FIGS. 8 and 9A-C). The polymer-particle layer 19 comprises a plurality of conductive particles 12 in an ionic polymer matrix. In some embodiments, all polymer-particle layers 19 that make up the each of the two extended electrode layers 31 may comprise the same concentration of well-dispersed conductive particles 12. The concentration profile along the thickness of such polymer composite would show a constant concentration within a certain depth from each electrode as depicted in FIG. 3A.

In some embodiments, the plurality of conductive particles 12 forms a concentration gradient in each of the two extended electrode layers 31, with a higher concentration at the outer surface of the extended electrode layers 31. In one embodiment, the concentration gradient may decrease linearly from the two opposite surfaces (18a and 18b) of the polymer composite 11 along the thickness of each extended electrode layer 31 (FIG. 3B). In another embodiment, the concentration gradient may decrease non-linearly from the two opposite surfaces (18a and 18b) of the polymer composite 11 along the thickness of extended electrode layers 31 (FIG. 3C). In embodiments with multiple polymer-particle layers 19, each polymer-particle layer 19 may have different concentration of conductive particles 12. In one embodiment, the inner most polymer-particle layer has a lowest concentration of conductive particles 12, and the concentration gradually increases in each polymer-particle layer 19 toward the outer most polymer-particle layer 19a. This may also result in a polymer composite with a concentration profile in FIG. 3B or 3C. The preferred embodiments would have conductive particle concentration profiles shown in FIGS. 3B and 3C, as they result in optimized electrical conductance and mechanical bending stiffness.

The dielectric ionic polymer layer 32 is a layer of ionic polymer membrane that is substantially free of conductive particles 12. Examples of ionic polymer useful for making dielectric ionic polymer layer include, but are not limited to: perfluoro-sulfonic polymer, perfluoro-carboxylic polymer, polystyrene-sulfonic polymer and perfluoro-tertiary ammonium polymer. The ionic polymer for the ionic polymer dielectric layer may or may not be the same as the ionic polymer for the extended electrode layers within the same device. The typical thickness of the dielectric ionic polymer layer may be about 10% to about 98%, preferably about 50% to about 90% and more preferably about 60% to about 80% of the entire polymer composite thickness.

In some embodiments, at least one conductive layer 13 can be deposited on the two opposite surfaces of polymer composite 11. The two opposite surfaces, the first surface 18a and the second surface 18b, of polymer composite 11 are also the outer surfaces of the extended electrode layers 31a and 31b (see FIG. 5). The conductive layers 13 are in contact with the two extended electrode layers, and serve as surface electrodes in an ionic polymer device. The conductive layer 13 may comprise a metal such as Au, Pt, Pd, Ir, Ru, Rh Ag, Al, Ni and Cu, non-metal such as conductive polymers, carbon nanotubes and graphite or other conductive materials. In some embodiments, the conductive layers 13 can be connected to a power supply 16 through terminals 15 and wires 17 to be configured as an actuator or a sensor element. The conductive layers 13 serves to ensure good electrical conductance (from terminals 15) throughout the surface planes, while the conductive particles 12 ensure the electrical conductance (from the conductive layers 13) along the thickness of the extended electrode layer 31.

FIG. 2 depicts certain embodiments of ionic polymer device comprising a polymer composite 11 with a plurality of nano- and/or micro-scale surface features 14 on two opposite surfaces of the polymer composite, and at least one conductive layer 13 on each of the two surfaces with surface features 14. The conductive layer 13 substantially covers the surface features 14. The interfacial area between the ionic polymer and the electrode of these embodiments are significantly increased, and thereby enhancing the performance of the ionic polymer device.

In some embodiments, the surface features 14 may be pores, grooves or tunnels, and are created by a surface imprinting technique to be described below. The depth of surface features on one surface of the polymer composite may be about 1% to about 45%, preferably about 5% to about 25% and more preferably about 10% to about 20% of the entire thickness of the polymer composite. The conductive layer 13 may comprise a metal such as Au, Pt, Pd, Ir, Ru, Rh Ag, Al, Ni and Cu, non-metal such as conductive polymers, carbon nanotubes and graphite or other conductive materials. In some embodiments, the at least one conductive layer also substantially covers the plurality of surface features. In other embodiments, the conductive layer may comprise a conductive thin film structure that was used as a template to form the surface features 14. In one embodiment, the thin film template is a porous silicon thin film structure.

### Conductive Nanoparticles Dispersed in Polymer

Several novel methods are described for making a variety of embodiments of the ionic polymer device shown in FIG. 1. Some embodiments provide a method for forming the polymer composite by “in-situ reduction,” wherein the metallic salt is reduced in the curing polymer composite to form nano- and/or micro-scale conductive metal particles in extended electrode layers. Other embodiments provide a method forming the polymer composite by using “preformed conductive particle dispersion” to create extended electrode layers. In general, the polymer composite is made first, and the conductive layers are then deposited on two opposite surfaces of the polymer composite to form the electrodes. Other steps such as cation exchange and solvent absorption for the polymer composite may be performed before or after the forming of electrodes.

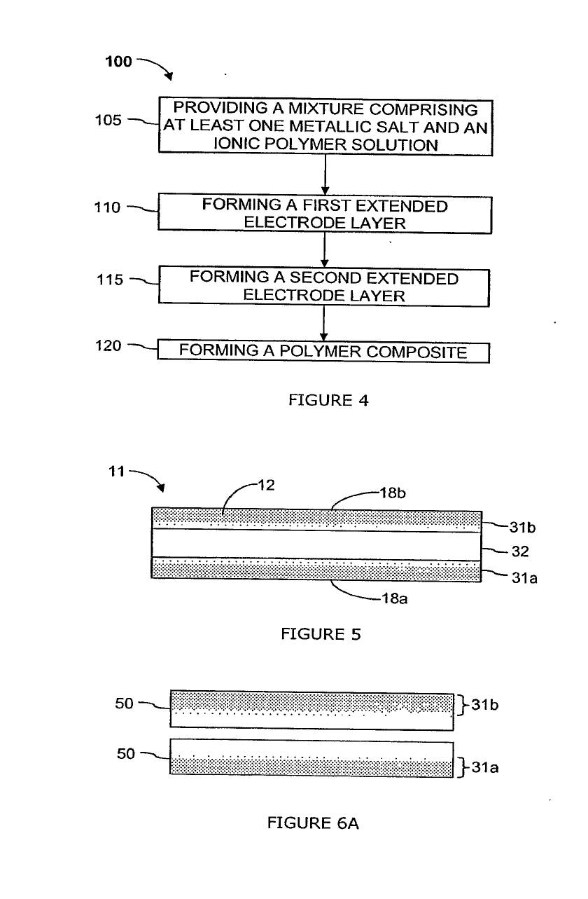

Some embodiments provide an in-situ reduction method for forming extended electrode layers in a polymer composite. In preferred embodiments, the ionic polymer solution can be made by mixing ionic polymers such as perfluoro-sulfonic polymer (Nafion®) or perfluoro-carboxylic polymer (Flemion®) in mixed solvents of water and alcohol. Suitable ionic polymer includes other polymer capable of ion conduction, and the examples are listed above. With reference to FIG. 4, the process for making an ionic polymer device 100 starts at step 105 by providing a mixture comprising at least one metallic salt and an ionic polymer solution. The mixture is a polymer-salt mixture or solution. The metallic salt is added into the ionic polymer solution and stirred rigorously. In some embodiments, the metallic salt may be HAuCl₄, [Au(phen)Cl₂]Cl, [Pt(NH₃)₆]Cl₂, H₂PtCl₆ or other Au or Pt salts. In one embodiment, some additive may be added to the mixture to improve the properties of the cured polymer, such as adding dimethylformamide (DMF) to prevent the polymer cracking.

The polymer-salt mixture can be transferred to a container configured to a desired dimension and shape for the curing process. In some embodiments, spin coating, printing such as ink-jet printing, or other thin film casting/deposition techniques may be used for making a thin polymer composite membrane. In some embodiments, the curing process may occur at room temperature under vacuum, such as about 0 to about 30 inHg (relative), preferably about 0 to about 15 inHg and more preferably about 5 to about 10 inHg. The cured polymer composite is then annealed at an elevated temperature under vacuum. For examples, at a temperature of about 50 to about 200° C., preferably about 70 to about 150° C. and more preferably about 90 to about 120° C. and under vacuum at about 0 to about 30 inHg (relative), preferably about 10 to about 30 inHg and more preferably about 20 to about 30 inHg. In other embodiments, the curing process may occur at an elevated temperature under vacuum without annealing. For examples, the temperature range may be about 23 to about 150° C., preferably about 50 to about 100° C. and more preferably about 80 to about 90° C., and the vacuum range may be about 0 to about 30 inHg (relative), preferably about 0-15 inHg and more preferably about 5 to about 10 inHg. The most preferably condition would be at about 80° C. and under vacuum at about 5 inHg rel.

The process continues at step 110 by forming the first extended electrode layer 31a. When the polymer-salt mixture is partially cured to have a certain viscosity, a first portion of the reducing agent such as sodium citrate, sodium borohydride or HCHO is added to reduce the metallic salt and to form nano- and/or micro-scale metal particles (i.e., conductive particles 12) inside the curing polymer. A skilled artisan would be able to determine when the polymer-salt mixture is partially cured by observation of the curing polymer surface or by measuring the viscosity with a Rheometer. The reducing agent is typically introduced or added over the second surface 18b of the curing polymer layer. The second surface 18b is oriented so that it faces up and away from the gravitational pull. In some embodiments, a micro-sprayer may be used to introduce the reducing agent to ensure that the droplets are small and uniformly distributed across the second surface 18b. The conductive particles 12 precipitate and move toward the opposite first surface 18a due to the gravity. The first extended electrode layer 31a is formed at and near the first surface 18a of the curing polymer. By adjusting the rate of introduction of the reducing agent, a particle concentration gradient with a higher concentration at the first surface 18a can be achieved.

After allowing the polymer to cure further, the process continues at step 115 by forming the second extended electrode layer 31b. The second portion of the reducing agent is added over the second surface 18b when the polymer is nearly cured to form additional metal particles. Since the polymer has become more viscous at this point of the curing process, the reduced conductive particles 12 move toward the first surface 18a more slowly and settle at and near the second surface 18b to form the second extended electrode layer 31b. The mid-section of the cured polymer composition would be substantially free of conductive particles 12, and therefore is an ionic polymer dielectric layer 32.

In some embodiments, various amount of the reducing agent may also be introduced several times at various stages of the curing process to control the concentration profile. In some embodiments, the metallic salt is reduced in the curing polymer solution to form substantially spherical particles with sizes ranged from about 0.1 nm to about 1 μm, preferably about 1 nm to about 100 nm, and more preferably about 1 to about 10 nm. In other embodiments, the metallic salt may be reduced in the polymer composite to form cluster chains with diameters ranged from about 0.1 nm to about 1 μm, preferably about 1 nm to about 100 nm, and more preferably about 1 to about 10 nm and the length ranged from about 1 nm to about 10 μm, preferably about 50 nm to about 1 μm. In some embodiments, surfactant such as tetraoctyl ammonium bromide (TOAB), thio group and dendrimers, etc. may be added to prevent conductive nanoparticles from aggregating.

Some embodiments provide another in-situ reduction method for forming polymer composite, comprising forming at least two polymer layers or blocks and combining them to form a polymer composite. The process begins at mixing the polymer-salt solution as described above in step 105, but the amount of polymer-salt solution used may be adjusted to form a polymer layer with a thickness equal to or less than half of the desired thickness of the final polymer composite 11. The process continues at forming a first extended electrode layer 31a as described above in step 110. Instead of continue to forming a second extended electrode layer, the polymer layer 50 with one extended electrode layer is allowed to be cured completely. A person skilled in the art would understand that the rate that reducing agent is introduced can determine the thickness and the concentration profile of the extended electrode layer 31. Two such cured polymer layers 50 may be formed in one step in two separate containers or by cutting one large cured polymer layer 50 into two sections.

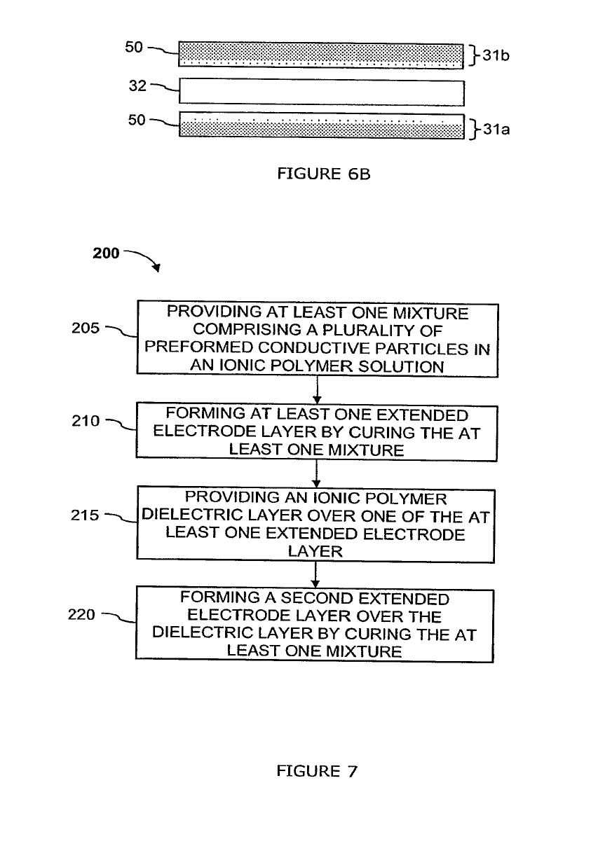

The next step involves forming the multi-layer ionic polymer composite 11 by combining two cured polymer layers 50. One of the cured polymer layers 50 is flipped up-side down so the surface with higher conductive particle concentration is facing up and away from the pull of gravity. In some embodiments, the cured polymer layers 50 may have a narrower concentration gradient, or a part of each of the cured polymer layers 50 may be substantially free of the conductive particles 12 as shown in FIG. 6A. Such two cured polymer layers 50 may be bonded together by joining the surfaces that are substantially free of the conductive particles 12. The portion of each polymer particle layers that is substantially free of the conductive particles 12 together form the ionic polymer dielectric layer 32.

In other embodiments where a thicker ionic polymer dielectric layer may be desired, a separate ionic polymer dielectric layer substantially free of conductive particles 12 may be used. The dielectric layer may be a pre-made ionic polymer, either commercially available or pre-cured. This ionic polymer layer is sandwiched between the two polymer layers 50 and all layers are bonded together to from a polymer composite 11 as depicted in FIG. 6B. In some embodiments, a small amount of ionic polymer solution may be used as an adhesive between the bonding layers. The bonding of the layers involves applying pressure to the stack of layers such as clamping the stack between two glass slides or simply placing heavy weight over the stack. The bonded stack was then heated at an elevated temperature ranged from about 50 to about 200° C., about 80 to about 150° C. and more preferably about 90 to about 120° C. under vacuum ranged from about 0 to about 30 inHg (relative), preferably about 5 to about 20 inHg and more preferably about 10 to about 15 inHg to re-dissolve the adjacent polymer phases and merge all the films together seamlessly to form a polymer composite 11 with a sandwiched structure.

Several embodiments provide a method for making an ionic polymer composite of an ionic polymer device using preformed conductive particles. Non-limiting examples of preformed conductive particles may be preformed or commercially available metal particles, conductive fibers or cluster chains, graphite, carbon nanotubes, conducting polymers, and any combination thereof. Preformed metal particles may be self-synthesized or commercial nanoparticles or powders. Non-limiting examples of preformed metal particles include gold nanoparticles in alcohol with particle size less than about 100 nm, preferably less than about 10 nm, and silver nanoparticles with a particle size less than about 100 nm, preferably less than about 10 nm.

With reference to FIG. 7, the process 200 starts at step 205 by providing at least one mixture comprising a plurality of conductive particles in a first ionic polymer solution (i.e., polymer-particle mixture). The ionic polymer solution can be made by mixing ionic polymers such as perfluoro-sulfonic polymer (Nafion®) or perfluoro-carboxylic polymer (Flemion®) in mixed solvents of water and alcohol. Other suitable ionic polymer includes polystyrene-sulfonic polymer and perfluoro-tertiary ammonium polymer, etc. Preformed conductive particles 34 are added into the ionic polymer solution to form a polymer-particle mixture of a desired concentration. The polymer-particle mixture is then ultrasonicated long enough for the well-dispersion of the preformed conductive particles 34. Surfactants such as tetraoctyl ammonium bromide (TOAB), thio group and dendrimers, etc. may also be used to prevent aggregation of preformed conductive particles 34. For example, TOAB-protected and thio-protected gold nanoparticles can be formed.

The process continues at step 210 by forming at least one extended electrode layer 31a by curing said at least one polymer-particle mixture. One of the at least one extended layer may be the first extended electrode layer 31a as depicted in FIG. 8. The first extended electrode layer 31a may comprise more than one polymer-particle layer 19 made from polymer-particle mixtures of the same or different particle concentrations. The mixture is cured on a substrate or in a container 35 at an elevated temperature and/or under vacuum to form a first polymer-particle layer 19a. Spin coating or other printing techniques may be used to form a thin polymer-particle layer if a thin ionic polymer device element is desired.

Optionally, one or more polymer-particle layers having different or the same particle concentration(s) can be formed on and over the first polymer-particle layer 19a. The first extended electrode layer 31a may be a single polymer-particle layer 19 or a combination of several polymer-particle layers. In one embodiment, the first polymer-particle layer 19a has the highest concentration of preformed conductive particles 34 and the second polymer-particle layer 19b has the second highest concentration. In other embodiments, additional polymer-particle layers having lower concentrations can also be formed on and over the second polymer-particle layer 19b. The first set of polymer-particle layers combined would form the first extended electrode layer 31a. The first extended electrode layer 31a has a concentration gradient that decreases from the outer surface of the first polymer-particle layer 19a toward the interface between the first extended electrode layer 31a and the next layer.

In embodiments where the cured polymer-particle layer or membrane is thin and the concentration of conductive preformed conductive particles 34 in the initial mixture is very high, the preformed conductive particles 34 may have a near constant concentration profile along the thickness of the cured polymer-particle layer 19. In other embodiments, a local concentration gradient may form in a cured polymer-particle layer due to the gravity. Such polymer-particle layers may be useful in forming an extended electrode layer 31 as well. A skilled artisan would be able to adjust the concentrations of each polymer-particle mixture for making each polymer-particle layer 19 to result in an extended electrode layer 31 having a particular desired concentration gradient according to embodiments of this invention.

The process then continues at step 215 by providing an ionic polymer dielectric layer. In some embodiment, a pre-made ionic polymer without conductive particles may be used. They are either commercially available or can be pre-cured. In other embodiments, providing an ionic polymer dielectric layer comprises providing a second ionic polymer solution and forming an ionic polymer dielectric layer 32 over the first extended electrode layer 31a by curing the second ionic polymer solution. The second ionic polymer solution can be made from any ionic polymer suitable for forming an ion-exchange membrane and the examples are described above. The second ionic polymer solution may or may not be the same as the first ionic polymer solution used in preparing the polymer-particle mixture in step 205.

The process moves on to step 220 by forming a second extended electrode layer 31b by curing said at least one polymer-particle mixture over the ionic polymer dielectric layer 32. The second extended electrode layer 31b preferably has the same type of concentration profile as the first extended electrode layer 31a, but the direction of the concentration gradient is reversed. For example, if multiple polymer-particle layers having different concentrations such as 19a and 19b are formed in step 210, the same multiple polymer-particle layers are form again over the ionic polymer dielectric layer 32 in the reversed order. The polymer-particle layer with the lowest particle concentration 19b is formed on the dielectric layer 32, and a higher concentration polymer-particle layer 19a is formed on the previous polymer-particle layer 19b. In a preferred embodiment, the first and the second extended electrode layers 31a and 31b together would exhibit a symmetric concentration profile. The thickness of each extended electrode layer 31 may be about 1% to about 45%, preferably about 5% to about 25% and more preferably about 10% to about 20% of the entire polymer composite thickness.

In some embodiments, the polymer composite is formed by combining two of the at least one extended electrode layer and the ionic polymer dielectric layer. The first and the second extended electrode layers 31a and 31b can be fabricated separately using preformed particle dispersion method. Subsequently, the two separately formed extended electrode layers are combined together with an ionic polymer dielectric layer 32 sandwiched in between the two extended electrode layers to form a single ionic polymer composite 11 (FIG. 9). The layers are combined by bonding them together as described above. In some embodiments, multiple polymer-particle layers that make up each extended electrode layer may also be formed separately and subsequently bonded to form an ionic polymer composite 11. Alternatively, a layer of dielectric ionic polymer may be formed directly on each of the extended electrode layers prior to bonding the two combined layers to form an ionic polymer composite.

The first and the second extended electrode layers 31a and 31b are fabricated separately according to the process described above in steps 205 and 210. In some embodiments, a larger strip of extended electrode layer is formed according to steps 205 and 210. The large strip can be cut in half to form the first and the second extended electrode layers 31a and 31b. The ionic polymer dielectric layer 32 is formed according to the process 200 in step 215.

All the separately formed layers (extended electrode layers or dielectric layer) or the polymer composite can be cured at room temperature under vacuum, and then annealed at an elevated temperature under vacuum. The vacuum range for room temperature curing is from about 0 to about 30 inHg (relative), preferably about 0 to about 15 inHg and more preferably about 5 to about 10 inHg. The annealing temperature is in the range of about 50 to about 200° C., preferably about 70 to about 150° C. and more preferably about 90 to about 120° C. The vacuum range for annealing is from about 0 to about 30 inHg (relative), preferably about 10 to about 30 inHg and more preferably about 20 to about 30 inHg. In other embodiments, the curing process may occur at an elevated temperature under vacuum without annealing. For examples, the temperature range may be about 23 to about 150° C., preferably about 50 to about 100° C. and more preferably about 80 to about 90° C., and the vacuum range may be about 0 to about 30 inHg (relative), preferably about 0 to about 15 inHg and more preferably about 5 to about 10 inHg.

Once the ionic polymer composite with desired particle concentration profile is fabricated using any one of the above methods, at least one conductive layer is deposited on each of the first and the second surfaces 18a and 18b to form electrodes. The conductive layers ensure good surface conductivity and uniform electric field along the length of the ionic polymer device. In embodiments where preformed layers are combined to form an ionic polymer composite, at least one conductive layer may be deposited onto the surfaces that will become the first and the second surfaces 18a and 18b of the polymer composite. Suitable materials for conductive layers include metals, conductive polymer, graphite or other materials that have good electrical conductivity and resistance to corrosion. Preferred materials for the electrodes 13 are metals such as Au, Pt, Pd, Ir, Ru, Rh Ag, Al, Ni and Cu, non-metal such as conductive polymers, carbon nanotubes and graphite or other conductive materials. The deposition of the conductive layer can be achieved by any suitable deposition and/or plating method, including but not limited to sputter coating, electroless plating, vacuum deposition, spraying, painting, brushing, dipping and pressing at high pressure and/or high temperature.

In other embodiments, surface treatments may be performed to increase the surface area for better bonding with the conductive layer 13. These surface treatments may be surface roughening, plasma surface treatment or other similar treatments. Optionally, a cleaning process such as ultrasonic cleaning or acid washing may also be performed prior to the metal deposition steps.

Since cation movement within the cluster network of an ionic polymer composite upon electrical stimulation causes actuation, the actuation performance can be altered by changing the associated cation. In some embodiments, the cations of the ionic polymer composite can be replaced with one or more of cations such as alkali metal cations, alkaline earth metal cations, poor metal cations and alkyl ammonium via ion-exchange procedures. Alkali metal cations are Li⁺, Na⁺, K⁺, Rb⁺ and Cs⁺, etc., alkaline earth metal cations may be Ca²⁺ and Mg²⁺, etc, and poor metal cations may be Al³⁺ and Tl³⁺, etc. Alkyl ammonium cations include but not limited to tetrabutylammonium (TBA⁺) and tetramethylammonium (TMA⁺). Different combinations of these cations can be explored to obtain a desired actuation performance and property. In some embodiments, small alkali metal cation samples show a larger deformation rate but a small overall deformation (actuation displacement). In other embodiments, larger alkyl ammonium cation shows larger overall deformation, but a small deformation rate.

In some embodiments, solvent absorption is also performed to allow the interconnected cluster network to form in the ionic polymer composite. As cation movement is aided by the solvent, ionic polymer actuator with different solvent type or amount can show different actuation performance. The solvent includes but not limited to water, organic solvents such as ethylene glycol, glycol, glycerol or crown ethers or ionic liquids such as 1-ethyl-3-methylimidazolium trifluoromethanesulfonate. In some embodiments, the ion exchange and the solvent absorption may also be done prior to depositing the conductive layers.

### Surface Imprinting

Another embodiment provides a novel method for increasing the interfacial area between the ionic polymer phase and the electrically conductive phase or the electrode by forming an ionic polymer composite with imprinted surface features for contacting the electrodes. Suitable ionic polymer includes any polymer capable of ion conduction, such as perfluoro-sulfonic polymer (Nafion®), perfluoro-carboxylic polymer (Flemion®), polystyrene-sulfonic polymer and perfluoro-tertiary ammonium polymer. In preferred embodiments, the ionic polymer composite is formed using Nafion® or Flemion® polymer solution. These polymer solutions are made by mixing Nafion or Flemion in mixed a solvent of water and alcohol. The imprinted surfaces of an ionic polymer composite comprise nano- or micro-scale surface features such as pores, groove and tunnels.

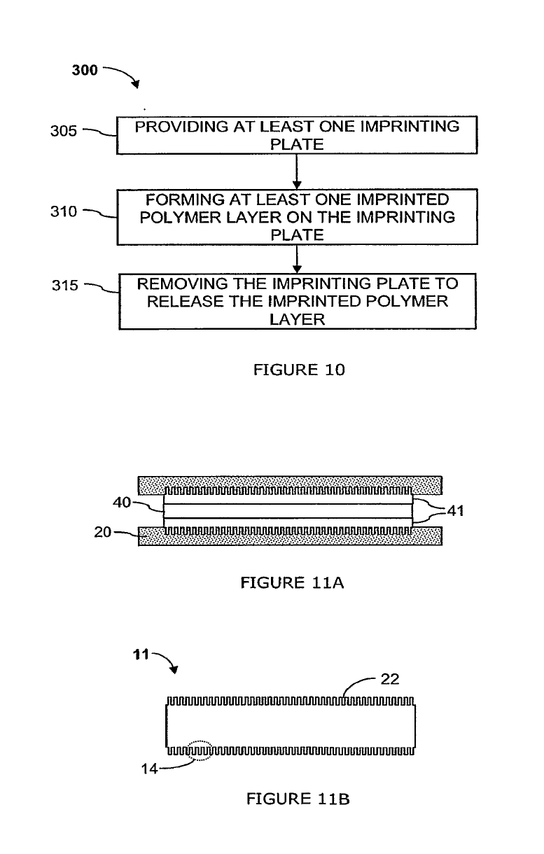

With reference to FIG. 10, the imprinted polymer composite can be fabricated using the process 300, which starts at step 305 by providing at least one imprinting plate 20. At least one imprinting plate 20 is used as a template for creating nano- and/or micro-scale surface features 14 on the two opposite surfaces of an ionic polymer composite 11 that will be in contact with the electrodes 13. The imprinting plate 20 may be any plate with nano- or micro-scale indentation, protrusion and holes, etc. Preferable materials for imprinting plates are semi-conducting and conducting materials such as porous silicon (preferably heavily doped) and etched metal. Metals that are suitable for imprinting plates include, but not limit to: Au, Pt, Pd, Ir, Ru, Ag, Al, Ni and Cu.

In some embodiments, the imprinting plate 20 can be made by electrochemically etching conducting or semi-conducting materials. In one embodiment, a porous silicon imprinting plate can be made by electrochemical etching of a boron-doped, P⁺⁺-type <100> silicon wafer in about 10% hydrofluoric acid (HF) ethanoic/aqueous solution. The HF ethanoic/aqueous solution is made by mixing 48% wt of HF aqueous solution with 200-proof ethanol in a 1:4 volume ratio. Other etching solution may include any combination of a fluoride salt with an acid that can produce H⁺ and F⁻. In one embodiment, the etching solution may be a combination of HNO₃ and NH₄F. In another embodiment, an aluminum foil may be etched by HCl and/or HNO₃.

The porosity and the pore size can be tailored by changing the etching conditions. The variable etching conditions are: concentration of the etching solution, duration of etching, applied electrical function, etching sequences and any combination thereof. In some embodiments, HF ethanoic/aqueous solution may be about 1% to about 99% by volume, preferably about 5% to about 50% by volume, and more preferably about 10% to about 38% by volume in concentration. The duration of etching depends on the concentration of the etching solution, and can range from about 1 second to about 1 hour, preferably about 10 seconds to about 10 minutes and more preferably about 30 seconds to about 5 minutes. The applied current density also depends on HF concentration, and may be about 1 to about 10,000 mA/cm² and preferably about 10 to about 2,000 mA/cm².

The surface of a porous plate may be characterized by scanning electron microscope (SEM), reflectivity spectrometer, and/or atomic force microscope (AFM). One embodiment of the porous silicon plate exhibits a large porosity and an average pore diameter of less than about 5 nm. In preferred embodiments, imprinting plates 20 have relatively small pores (in nanometer scale) and large pore depth (in micrometer scale), and therefore a high aspect ratio of about 10 to about 100 or more. These imprinting plates also exhibit large porosity (about 70% to about 95% or higher), and thus large surface area to volume ratio. By characterizing and examining the imprinting plate surface, a skilled artisan would be able to adjust the etching parameters and conditions to create desired templates.

In some embodiments, highly porous materials for imprinting plates may be hydrophobic. Since imprinted surface features are made by casting an ionic polymer solution on to the imprinting plate and allowing the polymer solution to diffuse into the porous matrices of the imprinting plate, proper surface modification may be necessary to change the surface chemistry. For example, oxidization (changing Si—H to Si—O) of a silicon imprinting plate can make the surface more hydrophilic, so the ionic polymer solution can penetrate into the holes and indentations on the imprinting plate more easily. In one embodiment, the porous silicon imprinting plate is placed in a furnace at about 600° C. for about 2 hours to oxidize the silicon surface.

The process 300 continues at step 310 by forming at least one imprinted polymer layer on the imprinting plate. Ionic polymer solution is applied or cast onto the imprinting plates 20 and allowed to cure into an imprinted polymer layer 41. One embodiment provides the method of making an ionic polymer composite with surface features by curing a polymer composite between two imprinting plates 20. With reference to FIG. 11A, the polymer solution is applied onto the surfaces of two imprinting plates 20. A solid (pre-cured) ionic polymer 40 may be place in between two imprinting plates with applied polymer solution, and the sandwich structure is clamped down during the curing process. In some embodiments, the polymer solution is introduced into a desired container with two parallel imprinting plates 20. The polymer solution may also be forced into the holes and indentations of the imprinting plates 20 by heat or pressure. Once the polymer solution is cured, the imprinting plates 20 can be removed to yield a free-standing ionic polymer composite 11 having surface features 14 such as pores, tunnels or grooves on two opposite surfaces as depicted in FIG. 11B.

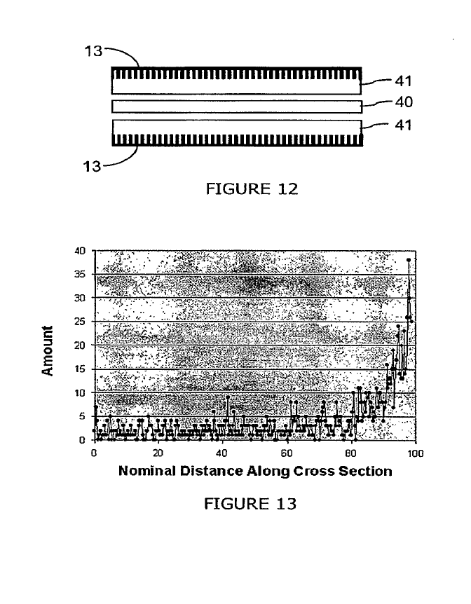

In other embodiments, polymer composites with nano- or micro-scale features/pores can also be fabricated by imprinting one surface at a time. The polymer solution is applied onto at least one imprinting plate 20 and allowed to cure to form an imprinted polymer 41. In some embodiments where a thin polymer layer is cast onto a single imprinting plate, additional polymer solution may be applied or added onto the thin polymer layer as a reinforcement layer while it is still attached to the imprinting plate 20. Once the imprinted polymer layer is cured and released from the imprinting plates 20 (as describe in the step 315 below), two imprinted polymer layers may be bonded together with surface features facing outward to form a polymer composite 11. Additional polymer solution may be used as an adhesive between the two imprinted layers. Alternatively, the separately cured imprinted layers may also have at least one conductive layer 13 deposited/plated on the surface features 14 first prior to bonding by joining the surfaces without the surface features (FIG. 12). The deposition/plating of the conductive layer 13 is the same as described above.

In some embodiments, a polymer-salt solution made by step 105 can be used to make the imprinted polymer layer 41, and the reducing agent 19 is added as described in step 110 to form conductive particles 12 at and near the surface with surface features 14. In other embodiments, a polymer-particle mixture made by step 205 can also be used to make the imprinted polymer layer 41. The same technique described in step 210 is used to form an extended electrode layer with the imprinted surface 22. In embodiments where conductive particles, either formed by in-situ reduction or preformed particle dispersion method, a dielectric ionic polymer layer 40 may be used as a center layer when bonding two imprinted layers comprising conductive particles together to form an ionic polymer composite 11.

The process 300 continues at step 315 by removing the imprinting plate to release the imprinted polymer layer. Removing imprinting plates may comprise chemical etching with an acid or a base. In some embodiments where porous silicon templates are used, the porous silicon imprinting plate can be removed by etching away its surface structures with a strong base such as NaOH or KOH, thereby releasing the imprinting plates 20 from the newly formed porous surfaces of polymer composite 11. The polymer composite 11 with attached imprinting plates 20 is typically immersed in the etching solution to allow the polymer composite 11 to pill off the attached imprinting plates. In some embodiments, the polymer composite 11 or polymer layer with attached imprinting plates may also be soaked in a basic solution such as NaOH for several hours to allow the imprinting plates to be removed. The free-standing polymer composite 11 is allowed to dry in air.

In the illustrated embodiments, once the polymer composite 11 is released from the imprinting plate 20, one or more conductive layers 13 may be deposited on both porous surfaces of the polymer composite 11 to form electrodes. In some embodiments, the at least one conductive layer also substantially covers the plurality of surface features. Suitable materials for conductive layers include metals, conductive polymer, graphite or other materials that have good electrical conductivity and resistance to corrosion. Preferred materials for the electrodes 13 are metals such as Au, Pt, Pd, Ir, Ru, Rh Ag, Al, Ni and Cu, non-metal such as conductive polymers, carbon nanotubes and graphite or other conductive materials. The deposition of the conductive layer can be achieved by any suitable deposition and/or plating method, including but not limited to sputter coating, electroless plating, vacuum deposition, spraying, painting, brushing, dipping and pressing at high pressure and/or high temperature.

In other embodiments, conductive imprinting plates may also serve as electrodes without having to remove the imprinting plates or depositing additional conductive layer. The imprinting plates that are suitable for serving as electrodes are electrically conductive at least along the direction of the thickness of a polymer composite. In some embodiments, the imprinting plates 20 are also mechanically flexible (low bending stiffness). This is usually the case when the imprinting plates are very thin. Sometimes a final surface plating/coating step may be necessary to improve the surface conductivity of the attached imprinting plates. Non-limiting examples of such imprinting plates include: freestanding thin porous silicon film etched from a heavily doped silicon wafer, porous metallic foil such as aluminum, gold or platinum, a network structure consisting of electrically conductive wires, and other non-metallic materials such as a conductive polymer. A freestanding thin porous silicon film may be fabricated from electrochemical etching of a heavily boron doped, P⁺⁺-type <100> silicon wafer. The electrically conductive wires include wires made of metal, silicon, carbon and carbon nanotubes, etc.

Since cation movement within the cluster network of an ionic polymer composite upon electrical stimulation causes actuation, the actuation performance can be altered by changing the associated cation. In some embodiments, the cations of the ionic polymer composite can be replaced with one or more of cations such as alkali metal cations, alkaline earth metal cations, poor metal cations and alkyl ammonium via ion-exchange procedures. Alkali metal cations are Li⁺, Na⁺, K⁺, Rb⁺ and Cs⁺, etc., alkaline earth metal cations may be Ca²⁺ and Mg²⁺, etc, and poor metal cations may be Al³⁺and Tl³⁺, etc. Alkyl ammonium cations include but not limited to tetrabutylammonium (TBA⁺) and tetramethylammonium (TMA⁺). Different combinations of these cations can be explored to obtain a desired actuation performance and property. In some embodiments, solvent absorption is also performed to allow the interconnected cluster network to form in the ionic polymer composite. As cation movement is aided by the solvent, ionic polymer actuator with different solvent type or amount can show different actuation performance. The solvent includes but not limited to water, organic solvents such as ethylene glycol, glycol, glycerol or crown ethers or ionic liquids such as 1-ethyl-3-methylimidazolium trifluoromethanesulfonate. In some embodiments, the ion exchange and the solvent absorption may also be done prior to depositing the conductive layers.

A cantilevered strip of an embodiment of ionic polymer device produced by the method of this invention can undergo a large bending vibration when a small alternating current (AC) such as about 1 to about 2 volts is applied across its thickness. In embodiments where the ionic polymer device is configured as an actuator, the amplitude of bending vibration can be about 5% to about 100% of the gage length. When a direct current (DC) is applied, the sample shows a fast bending motion toward the anode, followed by a slow motion in the same or opposite direction. In other embodiments, when the ionic polymer member is suddenly bent, a small electric potential at about several mV is produced across its surfaces, and can act as a sensor.

Potential applications of an ionic polymer device include, but not limited to, forming flexible manipulators for endoscopic surgery, catheter tips and guide wires, implantable micro pumps, lids of micro drug delivery devices with controlled drug release rate, artificial muscles, and deformation sensors (for bending, shearing or rotating). Some embodiments provide a medical device comprising an ionic polymer device or element, wherein the ionic polymer device can drive the motion and manipulate or guide the advancement of the medical device. For example, an endoscopic surgical tips may comprise one or more ionic polymer actuator elements/devices for controlling blades, scalpel, needle, needle holder/driver, hook, spatula, delivery instrument, endoscope, fiberoptic cable, light guide, forceps, scissors, dissector, shears, monopolar and bipolar electrocautery, clip applier and grasper. In some embodiments, more than one ionic polymer actuator elements can also be used to control the motion of more than one tip to achieve sophisticate motions and operations. In some embodiments, polymer actuators attached to, or integrated into the wall of a flexible catheter tube or cannula may control the bending motion of the catheter at a certain direction for a certain degree. Multiple segments of the tube wall are covered by separate ionic polymer device for an easy maneuver.

### EXAMPLE 1

### Nafion-Au Actuator Via Two-Time in-situ Reduction Method

2 mL of 5% Nafion alcohol solution was mixed with 1 ml of 10 mg/mL HAuCl₄ aqueous solution and then cured at an elevated temperate (about 80° C.) and moderate vacuum (about 5 inHg rel.) in a Teflon beaker. When the mixture becomes viscous, uniformly add 0.5 mL of 5 mg/mL NaBH₄ aqueous solution as a reducing agent from the second surface. A micro-sprayer may also be used to apply the reducing agent to ensure the small size and uniformity of the droplets. Alternatively, 0.5 ml of 25 mg/mL sodium citrate aqueous solution can be added as a reducing agent. The reduced gold nanoparticles then precipitated toward a first surface due to the gravitation, and a concentration profile was formed in the Nafion polymer matrix at and near the first surface.

When the mixture becomes even more viscous, another portion of the reducing agent is introduced from the second surface. Since the higher viscosity made it harder for the nanoparticles to move through the curing polymer, the reduced gold nanoparticles stayed at and near the second surface to form a concentration gradient in the Nafion polymer matrix. After the composite is completely cured, it is removed from the Teflon substrate. A higher temperature and a higher vacuum may be used to anneal the polymer prior to its removal from the substrate.

The following post-processing procedures were also used for different embodiments of polymer composites described in other examples. The composite was immersed in 1 mol/L NaCl solution over night for cation exchange from H⁺ to Na⁺. The composite membrane was dried in a vacuum oven prior to depositing or coating both the first and the second surfaces with gold. A sputter coater was used to deposit gold on each of the two surfaces for 2 minutes at 40 mA. The thickness of each gold layer is about 60 nm. Finally, the composite membrane was immersed in deionized (DI) water overnight to absorb the solvent into the ionic polymer.

A polymer composite with a thickness of about 80 μm in dry state was formed. The three layer structure, Nafion-Au, Nafion and Nafion-Au, was clearly visible in the optical microscope image of the cross-sectional view of the fabricated polymer composite. The SEM image of the polymer composite also revealed Au nanoparticles as small as 100 nm in the Nafion polymer matrix of the extended electrode layers. The sample showed a moderate actuation displacement when electric filed is applied.

### EXAMPLE 2

### Nafion-Au Actuator Via One-Time in-situ Reduction and Layer Bonding

3 mL of 5% Nafion solution, 1.5 mL of DMF and 2 mL of 10 mg/mL HAuCl₄ solution were mixed together and cured at an elevated temperate (about 80° C.) and moderate vacuum (about 5 inHg rel.) in a Teflon beaker. 3 mL of 25 mg/mL sodium citrate was added from the second surface when the polymer membrane becomes viscous. After the polymer was completely cured, its cross section was characterized using SEM and energy dispersive X-ray scanning (EDS). A SEM image of the cross-section of the extended electrode layer near the first surface shows that well-dispersed gold nanoparticles of about 50 nm are present near the first surface in the Nafion polymer matrix. FIG. 13 is an EDS analysis result showing the concentration gradient profile of the Au nanoparticles along the extended electrode layer thickness. The gold nanoparticles were more concentrated at and toward the first surface, with gradually decreasing concentration as moving away from the first surface. The gold concentration is nearly zero at and near the opposite surface.

The extended electrode layer was then cut into two parts and bonded together with both first surfaces (where higher concentration of Au nanoparticles can be found) facing away from the plane of contact. A small amount of 20% Nafion alcohol solution was use to bond or glue two membranes in between two glass slides. Some pressure was applied thought weight from the top, or through clamps from the sides. The assembly was placed in an elevated temperate and some vacuum was applied to allow evaporation of solvent and bonding.

### EXAMPLE 3

### Nafion-Ag Actuator Via Preformed Conductive Particle Dispersion

Preformed silver nano-powder (SNP) with an average diameter of the particle size less than 100 nm was purchased from Aldrich. The SNP was dissolved in 5% Nafion alcohol solution and ultrasonicated for >24 hrs. The concentration was 200 mg/mL, as measured in milligram of SNP per milliliter of 5% Nafion solution. The formation of the extended electrode layer (i.e., Nafion-SNP layer) started out by applying 0.3 mL Nafion-SNP solution onto a glass slide covered with Teflon tape. The glass slide was placed in a silicone rubber mold (with an area of 2.25 in×1 in=14.5 cm²). The polymer was then cured at room temperature and under medium vacuum (about 15 inHg rel.) for a few hours until the solvent was evaporated. Then the Nafion-SNP layer was annealed at an elevated temperature (about 80° C.) and under low vacuum (about 2 inHg) for a few hours. Subsequently, a dielectric layer comprising Nafion was formed on the extended electrode layer by adding 2 mL of 5% Nafion solution over the extended electrode layer. The Nafion layer was cured at room temperature and under low vacuum (about 2 inHg), and was then annealed at a higher temperature (about 80° C.) under low vacuum (about 2 inHg) until the solvent was evaporated. A two-layer composite film comprising a Nafion-SNP layer (i.e., extended electrode layer) and a Nafion layer (i.e., dielectric layer) was form on the glass slide.

Two such polymer layers (still on the glass slides) were bonded together with 1 mL of 20% Nafion solution. Pressure was applied through the clamps at the sides of the glass slides. The bonded stack was then cured at 85° C. under some vacuum to re-dissolve the adjacent polymer phases and merge two films together seamlessly to form a polymer composite with a sandwiched structure. The polymer composite was cooled down gradually and immersed in DI water for a few hours to remove the composite from the glass slides.

The multi-layer polymer composite was analyzed in SEM. The SEM image showed that the composite had a total thickness of 80.9 μm (in the dry state). The thickness of Nafion-SNP layers (i.e., extended electrode layers) were 12.4 and 12.7 μm respectively. No crack was observed in between two bonded films. In addition, silver nanoparticles as small as 50 nm could be seen uniformly distributed in the Nafion matrix near the surface. The fabricated actuator/sensor element demonstrated very good actuation performance when small electric potential was applied. An actuator element fabricated by this method was stimulated using a square waveform of ±1 V at 0.5 Hz. The sample had a thickness of about 140 μm at the water-saturated state. The actuation behavior was recorded with a high-speed camera at 120 fps. The frames when applied voltage switched from +1 V to −1 V and from −1 V to +1 V were extracted, and the position of the actuator element in each frame represents the displacement amplitude at the switch of the applied voltage. Two adjacent frames were added up (overlapped) for measuring the deformation amplitude. The amplitude of actuation displacement can be calculated using the formula: 100%×maximum displacement/(gauge length×2). In this case, the deformation amplitude of sample was ±22% of the gauge length.

Another actuator element fabricated by above method was stimulated by a square waveform of ±2 V at 0.25 Hz. The sample had a thickness of about 177 μm at the water-saturated state, and displayed deformation amplitude of ±16%. The larger thickness may be a reason that contributes to the smaller deformation even at a higher applied voltage. However, it should be noted that actuation is a very complicated process that involves coupled chemo-electro-mechanical mechanism. Other factors that can contribute to actuation deformation include surface resistance, electrode morphology, solvent content, cation composition, structure uniformity and integrity, etc.

### EXAMPLE 4

### Imprinting Plates

Heavily boron-doped, P⁺⁺-type <100> silicon wafers were used to make imprinting plates or templates with an etching area of 1.13 cm². A porous silicon wafer was etched with 37.5% HF ethanoic and aqueous solution at 1500 mA for 30 seconds, and was then soaked in a solution of 9:1 (v:v) 49% aqueous HF:DMSO for 150 minutes for pore expansion. A large porosity and small spherical pores of 20 nm were observed in the SEM image. Another porous silicon wafer was first etched with low-concentration HF under a high current density in order to electropolish the silicon wafer surface, and then etched with 37.5% HF ethanoic and aqueous solution at 2000 mA for about 30 seconds. The SEM image of the cross-section of this imprinting plate indicates that pores of about 80 nm wide and about 20 μm deep were formed on the silicon substrate, and thus displayed an aspect ratio of about 250. Another wafer etched with 10% HF (thus a slower etching rate) solution showed non-spherical pores of about 30 nm or smaller, ultrahigh porosity of more than about 90% and pore depth of about 500 nm. Another sample was obtained by etching a silicon wafer with a 10% HF ethanoic/aqueous solution at 25 mA for about 180 seconds and then ultrasonicating in ethanol. A freestanding network structure consist of silicon nanowires of about 5 to about 8 nm in diameter and pores of about 50 nm in diameter was obtained and identified through SEM observation. The ultrasonication served to lift off the etched porous structure, as well as to break them down into smaller pieces. The porous thin film was originally located right above the silicon wafer substrate. The obtained nanostructures have very large surface-area-to-volume ratio.

### EXAMPLE 5

### Imprinted Nafion Actuator Fabricated Using Porous Silicon Template

A heavily boron-doped, P⁺⁺-type, <100> silicon wafer was etched with 10% HF ethanoic and aqueous solution at 23 mA (etching area 1.13 cm²) for 3 minutes and dried with ethanol. A template with surface features comprising small pores of a few nanometers and large pores of about 200 to about 400 nm was created on the wafer. To modify the surface property from hydrophobic to hydrophilic, the wafer was placed in a furnace at 600° C. for 2 hours to oxidize the silicon. The ionic polymer membrane was formed by applying a droplet of 5% Nafion alcohol solution onto the surface of the template, cured at room temperature under vacuum (about 27 inHg) for a few hours. To reinforce the polymer membrane, a droplet of 20% Nafion solution was applied onto the formed Nafion thin film as backbone, cured and annealed The entire structure was then placed in a 0.5 M NaOH solution to slowly remove the silicon template. A free-standing imprinted Nafion layer/membrane was then lifted-off the template and allowed to dry in air.

The imprinted surface of the Nafion membrane was characterized by SEM and AFM. Nanoscale surface features were observed in the SEM image of the Nafion membrane surface cast from the porous template. In comparison to a SEM image of a Nafion membrane surface cast from a non-etched flat silicon wafer, the surface roughness or surface area is greatly improved by imprinting from a nanoporous template. The AFM tapping mode surface scanning also confirmed the large surface area.

Two imprinted Nafion layers could then be bonded using the method described in the Example 3 to form an ionic polymer composite. Conductive layers could be deposited onto both imprinted surfaces either prior to or after the bonding.

1. An ionic polymer device comprising:
two extended electrode layers comprising a plurality of conductive particles, wherein the plurality of conductive particles form a concentration gradient in each of the two extended electrode layers;
an ionic polymer dielectric layer between two extended electrode layers; and
at least one conductive layer on outer surfaces of two extended electrode layers.

2. The ionic polymer device of claim 1, wherein the concentration gradient decreases from the outer surfaces of two extended electrode layers toward the ionic polymer dielectric layer.

3. The ionic polymer device of claim 1 configured as a sensor or an actuator.

4. An ionic polymer device comprising:
a polymer composite with a plurality of surface features on two opposite surfaces; and
at least one conductive layer on each of said two opposite surfaces.

5. The ionic polymer device of claim 4, wherein said at least one conductive layer substantially covers the plurality of surface features.

6. The ionic polymer device of claim 4, wherein said at least one conductive layer is also an imprinting plate.

7. The ionic polymer device of claim 4, wherein said polymer composite further comprises two extended electrode layers comprising a plurality of conductive particles, wherein each of the two extended electrode layers is at and near the two opposite surfaces.

8. The ionic polymer device of claim 4 configured as a sensor or an actuator.

9. A method of making an ionic polymer device, comprising:
providing a mixture comprising at least one metallic salt in an ionic polymer solution;
curing the mixture to form at least one partially cured polymer layer having a first surface and a second surface, wherein the at least one partially cured polymer layer comprises the at least one metallic salt; and
reducing said at least one metallic salt to form a plurality of metal particles, thereby forming a first extended electrode layer at and near the first surface.

10. The method of claim 9, wherein reducing the at least one metallic salt comprises adding a reducing agent to the at least one partially cured polymer layer over the second surface.

11. The method of claim 9, further comprising reducing said at least one metallic salt to form a plurality of metal particles, thereby forming a second extended electrode layer at and near the second surface.

12. The method of claim 11, wherein the plurality of metal particles forms a concentration gradient across each of the first extended electrode layer and the second extended electrode layer with a high concentration at the first surface and the second surface.

13. The method of claim 9, further comprising:
forming two cured polymer layers by allowing the at least one partially cured polymer layer to cure; and
combining the two cured polymer layers to form a polymer composite.

14. The method of claim 9, further comprising:
forming two cured polymer layers by allowing the at least one partially cured polymer layer to cure;
providing an ionic polymer dielectric layer between two cured polymer layers;
combining two cured polymer layers and the ionic polymer dielectric layer to form a polymer composite.

15. The method of claim 13, wherein the plurality of metal particles forms a concentration gradient across the first extended electrode layer with a high concentration at the first surface.

16. The method of claim 11, further comprising depositing at least one conductive layer on the first surface and the second surface.

17. The method of claim 14, wherein providing an ionic polymer dielectric layer comprises providing a second ionic polymer solution and curing the second ionic polymer solution to form a dielectric layer.

18. A method of making an ionic polymer device, comprising:
providing at least one mixture comprising a plurality of conductive particles in an ionic polymer solution;
forming at least one extended electrode layer comprising a plurality of conductive particles by curing the at least one mixture;
providing an ionic polymer dielectric layer on one of the at least one extended electrode layer; and
depositing at least one conductive layer on the outer surface of the at least one extended electrode layer.

19. The method of claim 18, wherein providing an ionic polymer dielectric layer comprises providing a second ionic polymer solution and curing the second ionic polymer solution to form a dielectric layer.

20. The method of claim 18, wherein the plurality of conductive particles in the at least one extended electrode layer forms a concentration gradient.

21. The method of claim 18, further comprising forming a second extended electrode layer on the dielectric polymer layer by curing said at least one mixture.

22. The method of claim 18, further comprising combining two of the at least one extended electrode layer and the ionic polymer dielectric layer.

23. A method of making an ionic polymer device comprising:
providing at least one imprinting plate;
providing an ionic polymer solution; and
applying the ionic polymer solution on the at least one imprinting plate, thereby forming at least one imprinted polymer layer with surface features.

24. The method of claim 23, further comprising removing the at least one imprinting plate and depositing at least one conductive layer on the imprinted polymer layer.

25. The method of claim 23, further comprising combining two imprinted polymer layers to form a polymer composite.

26. The method of claim 14, wherein the plurality of metal particles forms a concentration gradient across the first extended electrode layer with a high concentration at the first surface.

27. The method of claim 13, further comprising depositing at least one conductive layer on the first surface and the second surface.

28. The method of claim 14, further comprising depositing at least one conductive layer on the first surface and the second surface.
